(19) United States
(12) Patent Application Publication
(10) Pub. No.: US 2011/0078410 A1
(43) Pub. Date: Mar. 31, 2011

(54) EFFICIENT PIPELINING OF RDMA FOR COMMUNICATIONS

(75) Inventors: Robert S. Blackmore, Poughkeepsie, NY (US); Rama K. Govindaraju, Hopewell Junction, NY (US); Peter H. Hochschild, New York, NY (US); Chulho Kim, Poughkeepsie, NY (US); Rajeev Sivaram, West Orange, NJ (US); Richard R. Treumann, Highland, NY (US); Hanhong Xue, Poughkeepsie, NY (US)

(73) Assignee: International Business Machines Corporation, Armonk, NY (US)

(21) Appl. No.: 11/457,921

(22) Filed: Jul. 17, 2006

Related U.S. Application Data
(60) Provisional application No. 60/704,404, filed on Aug. 1, 2005.

(51) Int. Cl. G06F 12/00; G06F 15/76; G06F 9/02

(52) U.S. Cl. 712/30; 711/154; 711/E12.001; 712/E09.002

(57) ABSTRACT

Disclosed are a method of and system for multiple party communications in a processing system including multiple processing subsystems. Each of the processing subsystems includes a central processing unit and one or more network adapters for connecting said each processing subsystem to the other processing subsystems. A multitude of nodes are established or created, and each of these nodes is associated with one of the processing subsystems. A first aspect of the invention involves pipelined communication using RDMA among three nodes, where the first node breaks up a large communication into multiple parts and sends these parts one after the other to the second node using RDMA, and the second node in turn absorbs and forwards each of these parts to a third node before all parts of the communication arrive from the first node.

### RELATED APPLICATIONS

This application claims the benefit, under 35 U.S.C. 120, of provisional application No. 60/704,404, filed Aug. 1, 2005.

This application is related to copending application No. ______, (Attorney Docket No. POU920050108US3) for “Efficient Pipelining and Exploitation of RDMA for Multiple Party Communications,” filed ______, the entire disclosure of which is hereby incorporated by reference in its entirety.

### GOVERNMENT RIGHTS

This invention was made with Government support under Agreement No. NBCH3039004 awarded by DARPA. The Government has certain rights in the invention.

### BACKGROUND OF THE INVENTION

1. Field of the Invention

This invention generally relates to processing or computer systems, and more specifically, the invention relates to multiple party communications, such as collective communications or third party transfers, in parallel processing or computer systems.

2. Background Art

Multiple party communication operations, such as collective communications or third party transfers, in processing or computer systems (through MPI and other similar programming models) can cause a significant slow down in the running of parallel applications and the sustained performance as realized by the application. Most collective communications operations, for example, are generally implemented in software through the construction of a tree of the tasks in the parallel application.

Typical collective operations are: a) barrier; b) broadcast; c) reduce; and d) all reduce. For the barrier and all_reduce operations, the communication first goes up the tree and then comes down the tree. For the broadcast operation, the communication starts at the root and goes down the tree, and for the reduce operation, the communication starts at the leaves and goes up until it reaches the root task, which has the result of the reduction. The barrier and all reduce operations have the same communication pattern but the difference between these two operations is that in the case of a barrier operation, the message is just a single flag, whereas in the case of an all_reduce operation, the message can be as large as the size that can be specified by 64 bits.

Each of the above-identified operations suffers from a number of performance problems. For instance, a communication going up the tree incurs an overhead for the receivers, as they have to receive from all their children and they receive them in order since the CPU has to typically single thread the receives (since each parallel task has only 1 CPU assigned to it). A communication going down the tree incurs a serialization overhead in that the parent has to send data to all its immediate children.

Also, at any given stage of the operation, only tasks/processes in two levels of the software tree are active (one level that is sending and the other level that is receiving). So, only a small fraction of the overall processors are busy (especially for a large number of tasks).

### SUMMARY OF THE INVENTION

An object of this invention is to improve multiple party communication operations, such as collective communication or third party transfers, in computer systems.

Another object of the present invention is to use intelligent pipelining in conjunction with remote direct memory access exploitation to improve multiple party communication operations in parallel processing or distributed computer systems.

A further object of the present invention is to use cut-through or wormhole style routing through the software tree to allow more efficient pipelining of communications in a multiple party communication operation.

These and other objectives are attained with a method of and system for multiple party communications in a processing system including multiple processing subsystems. Each of the processing subsystems includes a central processing unit and one or more network adapters for connecting said each processing subsystem to the other processing subsystems. A multitude of nodes are established or created, and each of these nodes is associated with one of the processing subsystems.

A first aspect of the invention involves pipelined communication using RDMA among three nodes, where the first node breaks up a large communication into multiple parts and sends these parts one after the other to the second node using RDMA, and the second node in turn absorbs and forwards each of these parts (perhaps after operating on it, as in the case of reduce or all reduce) to a third node before all parts of the communication arrive from the first node.

In accordance with a second aspect of the invention, a tree is constructed having a multitude of nodes, each of the nodes representing a task in the processing system and being associated with one of the processing subsystems. These nodes include parent nodes and children nodes and each parent node has a plurality of children nodes, and at least one of the parent nodes has a respective one network interface adapter with each of the children nodes of said at least one of the parent nodes.

In accordance with this aspect of the invention, at least one parent node receives a first message from a first child node of said first parent node via the network interface adapter with said first child node and using remote direct memory access (RDMA). This parent node also receives a second message from a second child node of said first parent node via the network interface adapter with said second child node and using remote direct memory access.

Further benefits and advantages of the invention will become apparent from a consideration of the following detailed description, given with reference to the accompanying drawings, which specify and show preferred embodiments of the invention.

### BRIEF DESCRIPTION OF THE DRAWINGS

FIG. 1 is a simplified schematic diagram of a parallel processing system.

FIGS. 2A-2D identify four types of collective communication operations and illustrate how these operations have been performed in the past in the processing system of FIG. 1.

FIGS. 3A-3D illustrate a first aspect of the invention, in which child nodes send overlapping messages to their parent node.

FIGS. 4A-4E show how the broadcast operation can be performed using a wormhole or cut-through procedure in accordance with a second aspect of the present invention.

### DETAILED DESCRIPTION OF THE PREFERRED EMBODIMENTS

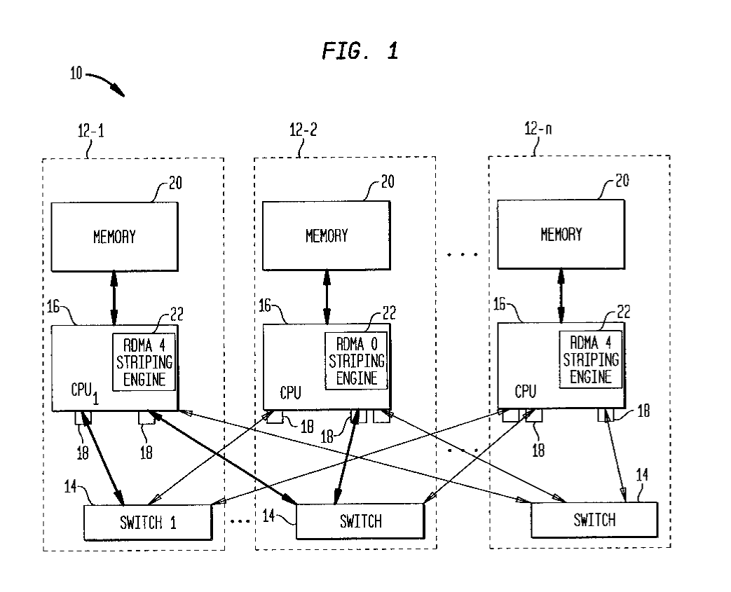

The present invention generally relates to multiple party communication operations in parallel processing or distributed computer systems, and the preferred embodiment of the invention uses remote direct memory access (RDMA) in parallel or distributed systems to improve multiple party communication operations in those systems. FIG. 1 illustrates a parallel processing system 10, configured to share data through RDMA, and with which, as an example, the present invention may be used.

More specifically, system 10 of FIG. 1 includes a multitude of parallel processing subsystems 12-1 through 12-n, each of which includes a switch 14, a CPU 16, an adapter 18, and a memory unit 20, and the CPU of each of the processing subsystems includes a RDMA and striping engine 22. Switches 14 provide the communication links associated with each subsystem 12-1 through 12-n that enables each subsystem to communicate with any other subsystem. RDMA and striping engine 22 are configured to enable communication between the subsystems; that is, for instance, subsystem 12-1 has access to subsystem 12-n, and more particularly to memory 20 of subsystem 12-n. RDMA and striping engines 22 enable the storage of data in a distributed fashion across memories 20 of subsystems 12-1 through 12-n.

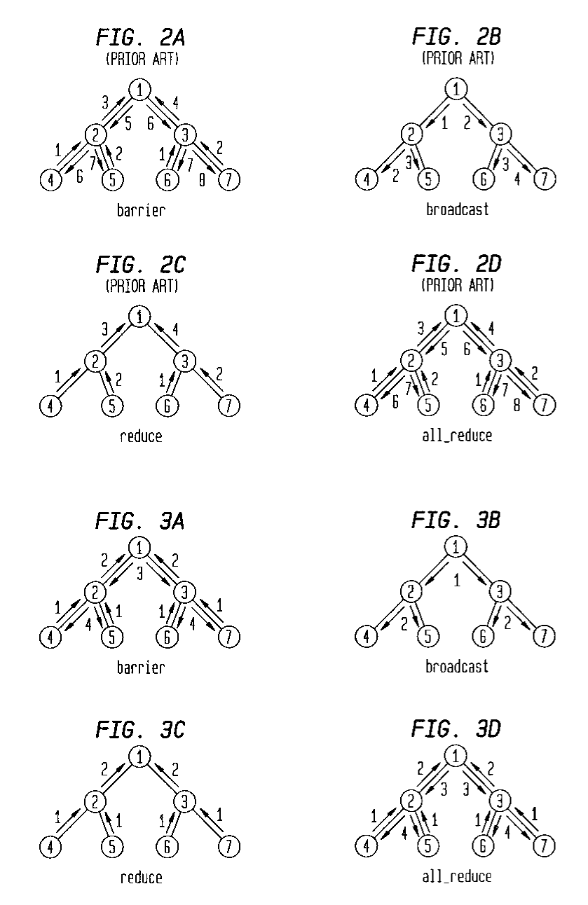

As indicated above, multiple party communications, such as collective communications or third party transfers, are used to transmit data among subsystems of system 100; and most collective communication operations, for example, are generally implemented in software through the construction of a software tree of the tasks in the parallel applications. Typical collective operations are: a) barrier; b) broadcast; c) reduce; and d) all reduce, and FIGS. 2A-2D show these four collective operations as they are usually implemented. In FIGS. 2A-2D, subsystems 12-1 through 12-n of system 100 are represented as circled nodes, numbered 1-7, and individual communication operations are represented as numbered arrows.

The arrow labels show the typical order of operations. Arrows with the same label are intended to occur concurrently. One of the basic assumptions in these operations is that there is one CPU assigned per task of the parallel application (which is a typical mode of operation for MPI applications on parallel systems). This limits the ability to use multiple threads to achieve more concurrency in these operations or if multiple threads are used by each process, it creates disruptive scheduling impacting the efficient running of these parallel applications.

Also, as mentioned above, there are a number of problems associated with each of the above-identified operations. One problem is that a communication going up the tree incurs an overhead for the receivers, as they have to receive from all their children and they receive them in order since the CPU has to typically single thread the receives (since each parallel task has only 1 CPU assigned to it). A communication going down the tree incurs a serialization overhead in that the parent has to send data to all its immediate children.

Another problem is that, at any given stage of the operation, only tasks/processes in two levels of the software tree are active (one level that is sending and the other level that is receiving). So, only a small fraction of the overall processors are busy (especially for large number of tasks). The total time for these operations is typically Θ(log(n)), where n is the number of the tasks in the collective operation. The example above shows a binary tree (α=2) but the implementations can have different fan out (a trees where the fan out is α, which can be greater than 2). This only changes the base of the log but does not help reduce the order of the overhead,

In addition, with α>2, the height of the tree can be made smaller but this increases the pipelining overhead at each intermediate stage. So this approach just trades off one bottleneck for another. In addition, the repeatability requirements enforce ordering constraints, which makes the out of order handling more complex with increasing α. So increasing α has some tradeoffs that need to be balanced and tuned based on the various system parameters.

The present invention solves the above-discussed problems. The solution to the first problem is achieved through an intelligent application of RDMA technology (See for example, U.S. patent application Ser. No. 10/929,943, for “Remote Direct Memory Access System And Method,” filed Aug. 30, 2004; U.S. patent application Ser. No. 11/017,406, for “Half RDMA and Half FIFO Operations,” filed Dec. 20, 2004; and U.S. patent application Ser. No. 11/017,574, for “Failover Mechanisms In RDMA Operations,” filed Dec. 20, 2004). The disclosure of the above-identified patent application Ser. Nos. 10/929,943, 11/017,406 and 11/017,574 are hereby incorporated herein by reference in their entireties.

RDMA does not involve the CPU in communication. Whereas normal approaches using the CPU in communication would result in all the serialization and other bottlenecks described above, RDMA can be done over multiple adapters concurrently because the adapters are directly transferring data from memory into the network and into the remote memory locations.

With prior art multiple party communications, most communication involves the CPU. With RDMA, though, the CPU is not involved in the communication path and message transfer occurs directly between local and remote memories (See for example, U.S. patent application Ser. No. 10/929,943, for “Remote Direct Memory Access System And Method,” filed Aug. 30, 2004; U.S. patent application Ser. No. 11/017,406, for “Half RDMA and Half FIFO Operations,” filed Dec. 20, 2004; and U.S. patent application Ser. No. 11/017,574, for “Failover Mechanisms In RDMA Operations,” filed Dec. 20, 2004.).

Multiple communication adapters are prevalent in present day “parallel subsystems” since these typically have multiple CPUs and therefore need multiple adapters to handle the overall communication load for the subsystem (e.g., large SMPs). In contrast to the above-discussed use of the CPUs to communicate multiple messages, RDMA coupled with multiple adapters can help alleviate the serialization bottleneck since multiple messages may be received separately on each of the adapters, and multiple communications can be initiated over each of the adapters as well.

The present invention effectively utilizes this RDMA technology to provide a solution to the above-discussed first problem. FIGS. 3A-3D illustrate an example of this solution. In this mode, when a parent receives from multiple children using RDMA through different interfaces, the two message receipts can be overlapped without requiring the CPU to be engaged, and hence parallelism is achieved by the receiving parent at each stage going up the tree. Similarly, using RDMA to send to each child going down the tree can also be accomplished through RDMA across multiple network interfaces (See for example, U.S. patent application Ser. No. 10/929,943, for “Remote Direct Memory Access System And Method,” filed Aug. 30, 2004; U.S. patent application Ser. No. 11/017,406, for “Half RDMA and Half FIFO Operations,” filed Dec. 20, 2004; and U.S. patent application Ser. No. 11/017,574, for “Failover Mechanisms In RDMA Operations,” filed Dec. 20, 2004.). With this mechanism, much better overlap for collectives can be achieved.

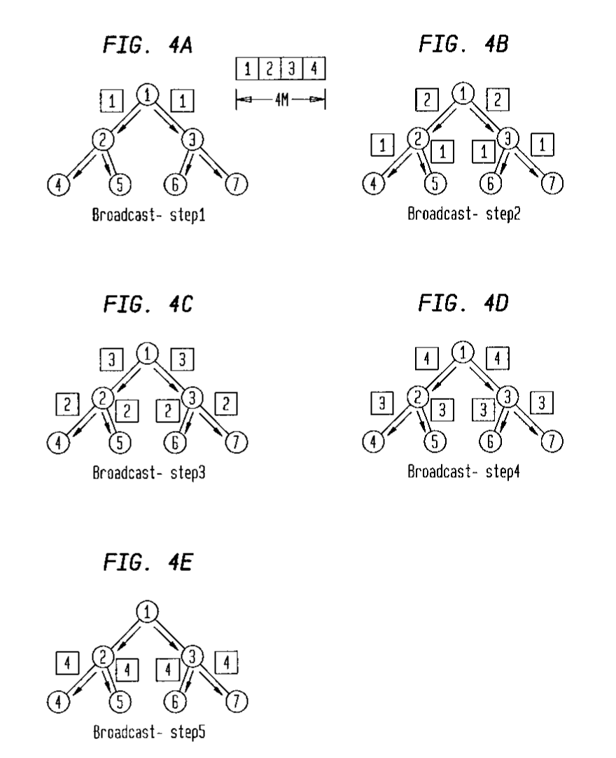

The second of the above-discussed problems is solved through intelligent pipelining in conjunction with RDMA exploitation which allows cut-through or wormhole style routing to allow much more efficient overlap of communication throughout the tree. This effect of cut-through routing is simulated by intelligent software controls. An example of this feature, used for a broadcast of a 4M message, is shown in FIGS. 4A-4E. In this example, the root uses RDMA over one network interface to submit 1M of the 4M message size to be sent to its left child. Immediately after that, the root submits the same 1M to be sent through RDMA over a second network interface to its right child.

Since the RDMA control requires a simple tap to the adapter, the two transfers of 1M to each of its children occurs concurrently with only a pipeline overhead of tapping the adapter. As soon as task 2 and task 3 receive the first IM from task 1, they forward that 1M through RDMA to their respective children and simultaneously receive the next 1M from their parent task 1. This, in effect, creates a cut-through routing effect for the entire message.

An important advantage of this feature of the present invention is that, without this pipelining, task 2 and task 3 would not send any data to their children until they had received the entire message. It should be noted that some pipelining efficiency can be achieved even without RDMA, but that pipelining would provide limited benefits because the CPU has to be involved in receiving all the data as well as to forward (sent) it to other tasks in the tree.

For large messages, the cut-through effects of the pipelining utilized in the preferred embodiment of this invention can result in a substantial increase in the efficiency of the collective operations. Another advantage of this embodiment is that, with such cut-through pipelining, messaging is in effect performed in most or all levels of the tree, except the initialization and the final drain stages of the collectives operation. It may be noted that this does not apply to the barrier case, where the message is just a single bit and does not lend itself to breaking it down for pipelining efficiency. However, this technique, although demonstrated for broadcast, applies to reduce and all reduce as well, as will be apparent to those skilled in the art.

The choice of the granularity at which the messages should be broken up would depend on the various system parameters and can be tuned to maximize performance. In the example of FIG. 4, 1M was chosen to illustrate the principles of the invention for achieving pipelining and cut through messaging for the various levels of the software tree.

It should be understood that the present invention can be realized in hardware, software, or a combination of hardware and software. Any kind of computer/server system(s)—or other apparatus adapted for carrying out the methods described herein—is suited. A typical combination of hardware and software could be a general-purpose computer system with a computer program that, when loaded and executed, carries out the respective methods described herein. Alternatively, a specific use computer, containing specialized hardware for carrying out one or more of the functional tasks of the invention, could be utilized.

Furthermore the invention may be practiced with other computer system configurations including hand-held devices, microprocessor systems, microprocessor-based or programmable consumer electronics, minicomputers, mainframe computers and the like. The invention may also be practiced in distributing computing environments where tasks are performed by remote processing devices that are linked through a network.

The present invention can also be embodied in a computer program product, which comprises all the respective features enabling the implementation of the methods described herein, and which—when loaded in a computer system—is able to carry out these methods. Computer program, software program, program, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

While it is apparent that the invention herein disclosed is well calculated to fulfill the objects stated above, it will be appreciated that numerous modifications and embodiments may be devised by those skilled in the art and it is intended that the appended claims cover all such modifications and embodiments as fall within the true spirit and scope of the present invention.

1-16. (canceled)

17. A method of processing collective operations in a parallel processing system, the method comprising:
receiving a message passing interface (MPI) operation message specifying a collective operation at a tree of processing nodes, wherein the MPI operation message is to be propagated to, received by and collectively processed by each of the processing nodes;
forwarding the MPI operation message and any associated data provided by upstream nodes between the nodes using multiple remote direct memory access (RDMA) transfers per MPI operation message;
propagating the MPI operation message and associated data by transferring portions of the MPI operation message from receiving nodes to next nodes in the tree of nodes simultaneously and before receipt of the complete MPI operation message has occurred at the receiving nodes; and
transferring MPI result messages containing portions of results of the MPI operation from child nodes of parent nodes within the tree of processing nodes to their corresponding parent nodes simultaneously, so that the parent nodes receive the MPI result messages from more than one of their associated child nodes out of sequential order.

18. The method of claim 17, wherein the MPI result messages are processed by a single thread at the processing nodes.

19. The method of claim 17, wherein the collective operation is an MPI barrier operation.

20. The method of claim 17, wherein the collective operation is an MPI reduce operation.

21. The method of claim 17, wherein the collective operation is an MPI all_reduce operation.

22. The method of claim 17, wherein the collective operation is an MPI broadcast operation.

23. The method of claim 17, wherein the portions are of equal size optimized to transfer characteristics among the tree of processing nodes.

24. A multiprocessor computer system, comprising a plurality of processing nodes interconnected by a communication network, wherein the processing nodes include a memory and a remote direct memory access (RDMA) engine for communicating directly with memories of other processing nodes, and wherein the processing nodes further comprise program instructions stored within the corresponding memory for execution by the processing node, wherein the program instructions comprise program instructions for:
receiving a message passing interface (MPI) operation message specifying a collective operation at a tree of processing nodes, wherein the MPI operation message is to be propagated to, received by and collectively processed by each of the processing nodes;
forwarding the MPI operation message and any associated data provided by upstream nodes between the nodes using multiple remote direct memory access (RDMA) transfers per MPI operation message;
propagating the MPI operation message and associated data by transferring portions of the MPI operation message from receiving nodes to next nodes in the tree of nodes simultaneously and before receipt of the complete MPI operation message has occurred at the receiving nodes; and
transferring MPI result messages containing portions of results of the MPI operation from child nodes of parent nodes within the tree of processing nodes to their corresponding parent nodes simultaneously, so that the parent nodes receive the MPI result messages from more than one of their associated child nodes out of sequential order.

25. The multiprocessor computer system of claim 24, wherein the MPI result messages are processed by a single thread at the processing nodes.

26. The multiprocessor computer system of claim 24, wherein the collective operation is an MPI barrier operation.

27. The multiprocessor computer system of claim 24, wherein the collective operation is an MPI reduce operation.

28. The multiprocessor computer system of claim 24, wherein the collective operation is an MPI all_reduce operation.

29. The multiprocessor computer system of claim 24, wherein the collective operation is an MPI broadcast operation.

30. The multiprocessor computer system of claim 24, wherein the portions are of equal size optimized to transfer characteristics among the tree of processing nodes.

31. A computer program product comprising a non-transitory computer-readable storage medium storing program instructions for execution by processing nodes within a multiprocessor computer system, wherein the nodes are interconnected by a communication network, wherein the processing nodes include a memory and a remote direct memory access (RDMA) engine for communicating directly with memories of other processing nodes, and wherein the program instructions comprise program instructions for performing collective operations within the multiprocessor computer system by:
receiving a message passing interface (MPI) operation message specifying a collective operation at a tree of processing nodes, wherein the MPI operation message is to be propagated to, received by and collectively processed by each of the processing nodes;
forwarding the MPI operation message and any associated data provided by upstream nodes between the nodes using multiple remote direct memory access (RDMA) transfers per MPI operation message;
propagating the MPI operation message and associated data by transferring portions of the MPI operation message from receiving nodes to next nodes in the tree of nodes simultaneously and before receipt of the complete MPI operation message has occurred at the receiving nodes; and
transferring MPI result messages containing portions of results of the MPI operation from child nodes of parent nodes within the tree of processing nodes to their corresponding parent nodes simultaneously, so that the parent nodes receive the MPI result messages from more than one of their associated child nodes out of sequential order.

32. The computer program product of claim 31, wherein the MPI result messages are processed by a single thread at the processing nodes.

33. The computer program product of claim 31, wherein the collective operation is an MPI barrier operation.

34. The computer program product of claim 31, wherein the collective operation is an MPI reduce operation.

35. The computer program product of claim 31, wherein the collective operation is an MPI all_reduce operation.

36. The computer program product of claim 31, wherein the collective operation is an MPI broadcast operation.

37. The computer program product of claim 31, wherein the portions are of equal size optimized to transfer characteristics among the tree of processing nodes.
